(19) United States
(12) Patent Application Publication
(10) Pub. No.: US 2018/0083472 A1
(43) Pub. Date: Mar. 22, 2018

(54) VARIABLE CAPACITOR SPEED UP CIRCUIT

(71) Applicant: QUALCOMM Incorporated, San Diego, CA (US)

(72) Inventors: Paolo MENEGOLI, San Jose, CA (US); Francesco CAROBOLANTE, San Diego, CA (US); Fabio Alessio MARINO, San Diego, CA (US)

(21) Appl. No.: 15/267,597

(22) Filed: Sep. 16, 2016

(51) Int. Cl. H02J 7/02; H02J 7/04; H02J 50/12

(52) U.S. Cl. CPC H02J 7/025; H02J 7/345; H02J 50/12; H02J 7/045

(57) ABSTRACT

Techniques for controlling a resonant network are disclosed. An example of an apparatus for varying capacitance in a resonant network includes a variable capacitor circuit configured to vary a capacitance in response to a control signal, at least one biasing component operably coupled to the variable capacitor circuit, and a control circuit configured to generate the control signal, such that the control signal includes a first tuning value corresponding to a first capacitance value, and output the control signal at the first tuning value to reduce an impedance of the at least one biasing component and vary the capacitance of the variable capacitor circuit, such that the impedance of the at least one biasing component subsequently increases when the first capacitance value is realized.

### FIELD

This application is generally related to wireless power charging of chargeable devices, and more particularly for using variable capacitors to tune a resonant network.

### BACKGROUND

A variety of electrical and electronic devices are powered via rechargeable batteries. Such devices include electric vehicles, mobile phones, portable music players, laptop computers, tablet computers, computer peripheral devices, communication devices (e.g., Bluetooth devices), digital cameras, hearing aids, and the like. Historically, rechargeable devices have been charged via wired connections through cables or other similar connectors that are physically connected to a power supply. More recently, wireless charging systems are being used to transfer power in free space to be used to charge rechargeable electronic devices or provide power to electronic devices. The transfer of power in free space may be dependent on the orientation of a transmitting and receiving units. Changes in the relative position of the transmitting and receiving units during charging operations can create stress on the circuit components. Rapid changes in position may overload and damage the circuit components. Wireless power transfer systems and methods that rapidly control and safely transfer power to electronic devices in such dynamic environments are desirable.

### SUMMARY

An example of an apparatus for varying capacitance according to the disclosure includes a variable capacitor circuit configured to vary a capacitance in response to a control signal, at least one biasing component operably coupled to the variable capacitor circuit, and a control circuit configured to generate the control signal, such that the control signal includes a first tuning value corresponding to a first capacitance value, and output the control signal at the first tuning value to reduce an impedance of the at least one biasing component and vary the capacitance of the variable capacitor circuit, such that the impedance of the at least one biasing component subsequently increases when the first capacitance value is realized.

Implementations of such an apparatus may include one or more of the following features. The at least one biasing component may include at least one switch configured to vary the impedance of the at least one biasing component based on the control signal. The at least one switch may include an n-channel metal-oxide-semiconductor field-effect transistor (MOSFET). The variable capacitor circuit may be part of a resonant network including a power receiving element and the control circuit may be configured to generate the control signal based at least in part on a voltage across the power receiving element. The variable capacitor circuit may be part of a resonant network including a battery charge controller and the control circuit may be configured to generate the control signal based at least in part on a system parameter in the battery charge controller. The variable capacitor circuit may include a transcap, an analog variable capacitor, a varactor, a Barium-Strontium Titanate (BST) dielectric, or combinations thereof. The control signal may be an analog voltage value. The first tuning value may be between 0.0 and 5.0 volts. The at least one biasing component may be a resistor. The at least one biasing component may be back-to-back diodes, a Resistor Capacitor (RC) network, an inductor, or combinations thereof.

An example of a method of controlling a resonant network with a variable capacitor according to the disclosure includes detecting a tuning signal associated with the variable capacitor, wherein the variable capacitor includes a biasing component, reducing an impedance of the biasing component based on the tuning signal, tuning the variable capacitor based on the tuning signal, and increasing the impedance of the biasing component.

Implementations of such a method may include one or more of the following features. Detecting the tuning signal may include comparing one or more voltage values. Reducing the impedance of the biasing component may include activating a switch configured to bypass the biasing component. Increasing the impedance of the biasing component may include activating the switch to not bypass the biasing component. Activating the switch configured to bypass the biasing component may include providing a voltage to one or more transistors. A system parameter associated with the resonant network may be detected, and the tuning signal may be based on the system parameter. The system parameter may be an output current. The system parameter may be a voltage across a power receiving element.

An example of an apparatus for changing a time constant of a variable capacitor according to the disclosure includes one or more variable capacitive elements, at least one high impedance biasing component operably coupled to the one or more variable capacitive elements, a switch operably coupled to the one or more variable capacitive elements and the at least one high impedance biasing component, such that the switch is configured to bypass the at least one high impedance biasing component when activated.

Implementations of such an apparatus may include one or more of the following features. The at least one high impedance biasing component may be a resistor. The at least one high impedance biasing component may be a back-to-back diodes, a Resistor Capacitor (RC) network, an inductor, or combinations thereof. The switch may include one or more transistors. The one or more transistors may include back-to-back n-channel metal-oxide-semiconductor field-effect transistors (MOSFETs). The one or more variable capacitive elements may include Barium Strontium Titanate (BST) devices. The one or more variable capacitive elements may include a transcap variable capacitor. The one or more variable capacitive elements may be part of a resonant network including a power receiving element and a control circuit, such that the control circuit is configured to provide a control signal to vary a capacitance value of the one or more variable capacitive elements based on a voltage in the power receiving element, and the switch is configured to activate based on the control signal.

An example of an apparatus for controlling a resonant network with a variable capacitor includes means for detecting a tuning signal associated with the variable capacitor, such that the variable capacitor includes a biasing component, means for reducing an impedance of the biasing component based on the tuning signal, means for tuning the variable capacitor based on the tuning signal, and means for increasing the impedance of the biasing component.

Implementations of such an apparatus may include one or more of the following features. The means for detecting the tuning signal may include means for comparing one or more voltage values. The means for reducing the impedance of the biasing component and the means for increasing the impedance of the biasing component may include means for activating one or more switches configured to bypass the biasing component. The apparatus may also include means for detecting a system parameter associated with the resonant network, and means for generating the tuning signal based on the system parameter.

An example of an apparatus according to the disclosure includes one or more variable capacitive elements, at least one variable biasing means for impeding current flow proximate to the one or more variable capacitive elements, and a control means for varying a capacitance value of the one or more variable capacitive elements and an impedance value of the variable biasing means.

Implementations of such an apparatus may include one or more of the following features. The variable biasing means may include a switch means operably coupled to the one or more variable capacitive elements and the control means, such that the switch means is configured to bypass at least one high impedance biasing component when activated. The switch means may include one or more transistors include back-to-back n-channel metal-oxide-semiconductor field-effect transistors (MOSFETs). The variable biasing means may include a resistor, a back-to-back diodes, a Resistor Capacitor (RC) network, an inductor, or combinations thereof.

Items and/or techniques described herein may provide one or more of the following capabilities, as well as other capabilities not mentioned. Output parameters may be controlled based on the tuning of a resonant network. The resonant network may be tuned by changing the values of one or more variable capacitors (e.g., tuning capacitors). The variable capacitors may include high impedance biasing components based on a desired quality factor (Q factor), linearity requirements, or other design considerations. The high impedance biasing components may impact the time constant of the resonant network. Changes in circuit parameters during charging operations may be detected. The resonant network may be tuned/detuned (i.e., the value of variable capacitors may be changed) in response to the circuit parameter changes. The high impedance biasing components may be bypassed and/or the value of the impedance in the biasing components may be reduced in response to the circuit parameter changes. The corresponding time constant associated with the variable capacitors may be shortened (e.g., a faster response time) based on the reduced impedance values. A tuning end point may be detected and the impedance values of the biasing components restored. The response time of the resonant network may be improved. The stress on circuit components may be reduced. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a functional block diagram of an example of wireless power transfer system.

FIG. 2 is a functional block diagram of an example of another wireless power transfer system.

FIG. 3 is a schematic diagram of a portion of transmit circuitry or receive circuitry of FIG. 2 including a transmit or receive antenna.

FIG. 4 is a diagram of an exemplary wireless power transfer system with a control loop on the receive circuitry.

FIG. 5 is a diagram of an example of a resonant network with a variable capacitor in a shunt configuration.

FIG. 6 is a diagram of an example of a variable reactive element with high impedance biasing components.

FIG. 7 is a multivariable graph of an example of signal response of a resonant network with the variable reactive element and high impedance components of FIG. 6.

FIG. 8 is a functional block diagram of an example of a circuit with a variable capacitor and a selectable biasing component.

FIG. 9 is a diagram of an example of a variable reactive element with a variable capacitor speed up circuit.

FIG. 10 is diagram of an example of a switch to selectively reduce the impedance associated with a variable capacitor.

FIG. 11 is a diagram of a mode complete circuit for a differential series configuration variable capacitor.

FIG. 12 is a multivariable graph of an example of signal response of a resonant network with a variable capacitor speed up circuit.

FIG. 13 is a flowchart of an example of a process of controlling a resonant network with a variable capacitor speed up circuit.

### DETAILED DESCRIPTION

Techniques are discussed herein for wireless power transfer using resonant circuits. Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

The output power of a receiver in a wireless power transfer may be controlled by varying the reactance of a resonant network (i.e., resonant circuit) within the receiver. One approach to changing and controlling the reactance in a resonant network includes varying the value of the capacitor in the resonant network. Variable capacitors may be used in some applications to change the reactance of a circuit. In general, there are two configurations of resonant networks. The first is series resonance, and the second is parallel resonance. Parallel circuits may also be referred to “shunt” configurations. In a circuit with a shunt resonance configuration, a capacitor is placed in parallel to the inductive elements in the resonant network. The inductive element may be the receiver antenna, which is typically described as an inductor with a series resistance. In the case of series resonant configuration, a capacitor is placed in series with the inductive elements (e.g., the receiver antenna).

In both the shunt and series configuration, the resonant circuit may be tuned or detuned in or out of resonance by varying the capacitance. Tuning the resonant circuit may also be used to vary the output of the receiver. For example, the amount of power that is transferred to the output may be varied by detuning or tuning to resonance. The resonant circuit may be tuned or detuned by adjusting the values of one or more variable capacitors (e.g., to vary the resonant tank impedance). As a general design consideration, a variable capacitor requires large impedance biasing components at each of its control terminals to reduce losses (e.g. to achieve an acceptable Quality factor (Q)). These high impedance biasing components increase the resistance associated with the input parasitic capacitances of the control terminals, limits bandwidth, frequency response and tuning speed of the variable capacitor. The tuning speed of the variable capacitors can be a critical factor in wireless power transfer systems because of the potential of relative movement between a transmitter and a receiver during charging operations. Such relative movement may increase the magnetic coupling and a corresponding increase in power transferred between the transmitter and receiver. This increase in power may cause damage to the receiver electronics if the resonant circuit is not rapidly detuned to compensate for the overvoltage condition.

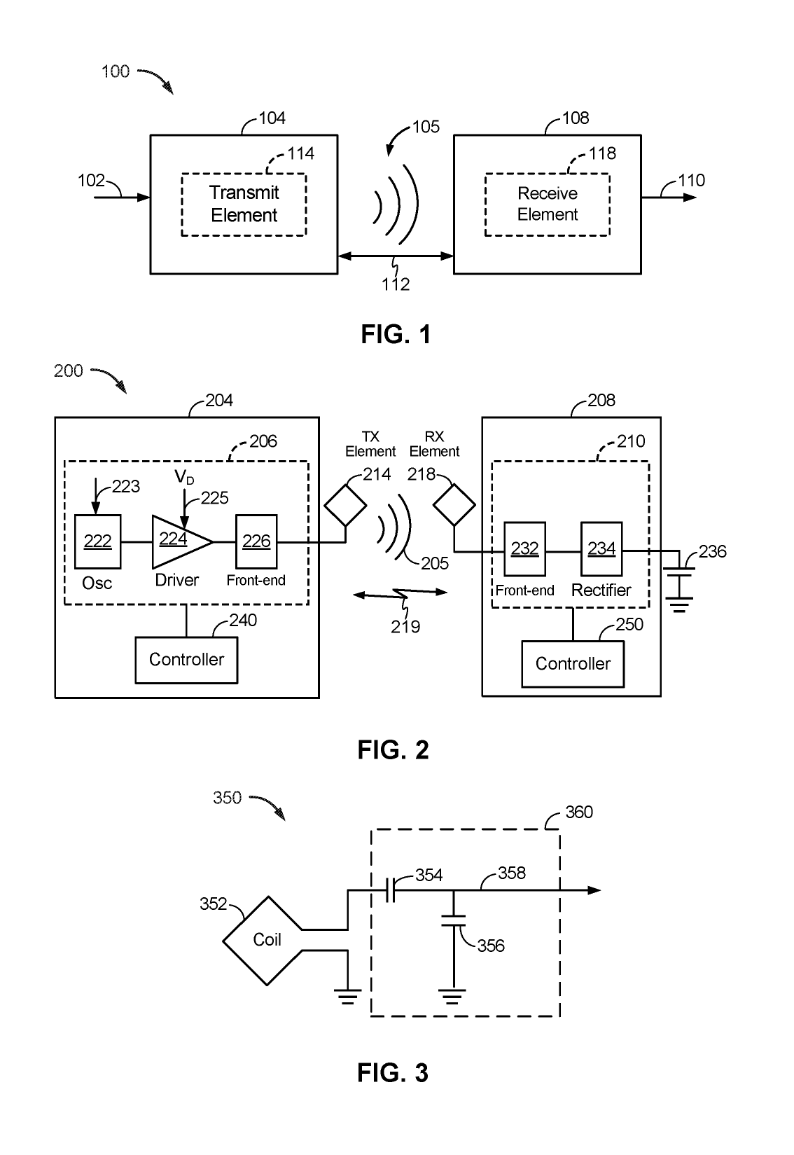

FIG. 1 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., to a battery via battery charge controller) or to power a load.

FIG. 2 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power transmitting element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power transmitting element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and generate an output power for storing or consumption by a battery (or load) 236 coupled to the output or receive circuitry 210. In this example, the generated output power is associated with the resonant circuit in the front end 232 because the tuning of the resonant circuit will impact the amount of output power generated.

The receiver 208 further includes a controller 250 that may be configured similarly to the transmit controller 240 as described above for managing one or more aspects of the wireless power receiver 208. The receiver 208 may further include a memory (not shown) configured to store data, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

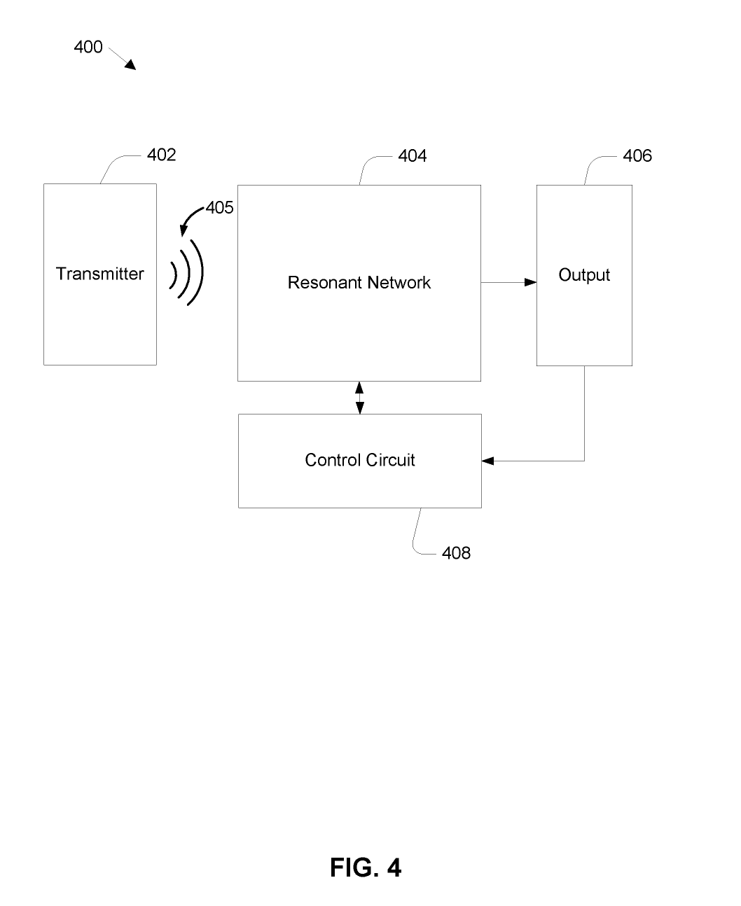

Referring to FIG. 4, a diagram of an exemplary wireless power transfer system 400 with a control loop on the receive circuitry is shown. The system 400 includes a transmitter 402 and resonant network 404 with a control circuit 408. The transmitter 402 is configured to output a time-varying field 405 (e.g., magnetic or electromagnetic) such as described for the transmit element 214. The resonant network 404 is configured to provide an output 406. The resonant network 404 may part of the front end 232 and the output 406 may receive an AC signal which is associated with the tuning of the resonant network 404. The output 406, for example, may be rectified (e.g., via rectifier circuit 234) for use in power applications (e.g., battery charging with a charge controller). In an example, the output 406 may be an impedance matching device (e.g., antenna matching in a communication system). A control circuit 408 may be part of the controller 250 and is operably coupled to the output 406 and the resonant network 404. The resonant network 404 comprises a resonant circuit with variable reactive elements (e.g., tuning capacitors, transcaps, variable capacitors, varactors, etc.) and the corresponding high impedance biasing components. The control circuit 408 is configured to detune the resonant network 404 away from resonance or tune the resonant network 404 closer to resonance by providing a control signal to the variable reactive elements. The control circuit 408 may be operably coupled to the variable reactive elements and configured to change the capacitive and/or biasing impedance values of the respective elements via one or more analog control signals (e.g., voltages). The control circuit 408 may be a means for generating control signals (e.g., a control means for varying the capacitance value of a variable capacitor). For example, the control circuit 408 may detect feedback parameter on the output 406 (e.g., an output current, a voltage, a standing wave ratio, or other parameter), generate a control signal based on the feedback signal, and provide the control signal to the biasing elements and/or the variable capacitors to detune or tune the resonant network 404 based on the value of the output 406. In an example, the control circuit 408 may be configured to receive additional circuit parameters such as receiver coil current or voltage in addition to, or in place of, the value of the output 406.

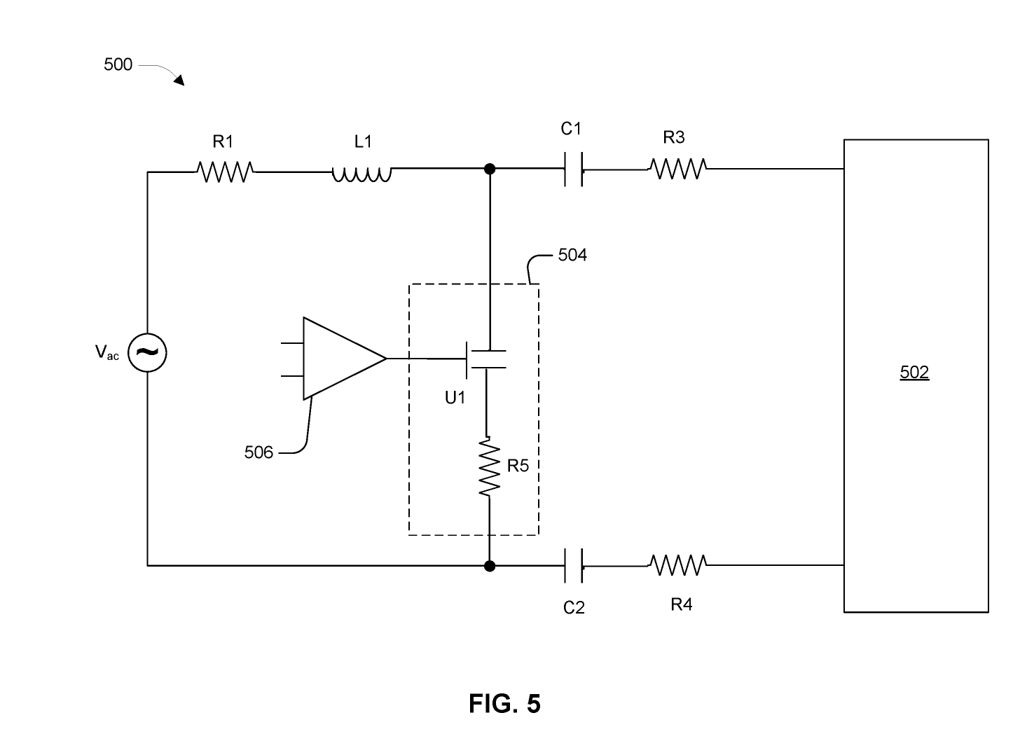

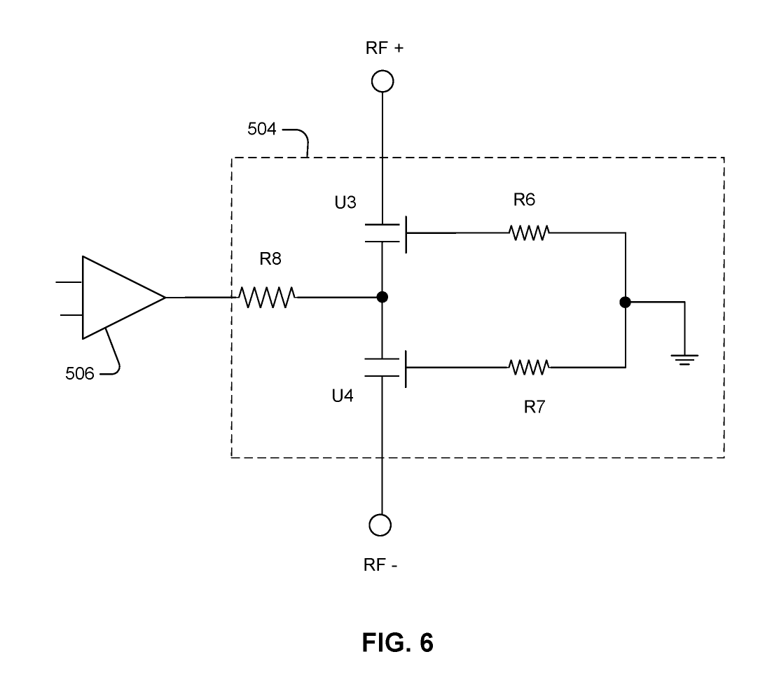

Referring to FIG. 5, a diagram of an example of a resonant network 500 with a variable capacitor in a shunt configuration is shown. The resonant network 500 is part of a PRU (e.g., receive circuitry 350) and is operably coupled to an output module 502. The output module 502 may include additional application specific circuity such as EMI filters, rectifiers, and other output circuits in the PRU (not shown). The resonant network 500 is a shunt configuration circuit. A voltage generator V_{ac} simulates an induced voltage (e.g., the voltage that is induced into the resonant network from a transmitter 402). R1 represents a series resistance and L1 represents the inductance of the antenna/coil (e.g., receiving element 352). The values of the discrete components in the resonant network will vary based on specific application and required performance (e.g., power output). A charging solution for a small consumer product, for example, may utilize values of R1 in a range between 500-1000 milliohms, and L1 may be in a range between 500-1000 nanohenries. The resonant network 500 includes a variable reactive element 504 in a shunt configuration. Examples of the variable reactive element 504 include a transcap, analog variable capacitor technologies, varactors, combinations of varactors, and Barium-Strontium Titanate (BST) dielectrics/devices. In an example, the variable reactive element 504 includes a variable capacitor U1 with a single control terminal operably coupled to an operational amplifier 506. A resistance R5 represents the internal resistance of the variable reactive element 504, and may have a value in the range of 10-100 milliohms. The variable capacitor U1 may be a semiconductor variable capacitor such as described in U.S. Patent Publication No. 2015/0194538, filed on Mar. 22, 2015, and titled “Multiple Control Transcap Variable Capacitor.” The resonant network 500 is an example of a balanced differential circuit in that it includes two equal branches between the variable reactive element 504 and the output module 502 (e.g., C1, R3 and C2, R4). The components C1 and C2, and R3 and R4 are part of the resonant network 500. In a charging solution for a small wearable device, example capacitance values for C1 and C2 may be in the range of 100 picofarads to 100 nanofarads, and the resistance values for R3 and R4 may be in the value of 1 to 100 milliohms. The resonant network 500 may also be referred to as hybrid series and parallel configuration because the total capacitance in the resonant network 500 is based partially on the series capacitors C1 and C2, and partially on the parallel variable reactive element 504. The overall impedance of the resonant network 500, however, may be controlled via the single control terminal on the variable capacitor U1. For example, the operational amplifier 506 may provide a voltage to the control terminal on the variable capacitor U1 to change the capacitive value of the variable capacitor U1. Thus, the output of the operational amplifier 506 may be used to tune and detune the resonant network 500 and thus vary the associated output.

Referring to FIG. 6, with further reference to FIG. 5, a diagram of an example of a variable reactive element 504 with at least one high impedance biasing component is shown. In an example, the variable capacitor U1 in FIG. 5 is comprised of the elements shown in FIG. 6. The variable reactive element 504 represents a general configuration of transcaps, varactors and/or BST elements known in the art. The variable reactive element 504 includes three high impedance biasing components as resistors R6, R7, R8 and two series capacitive elements U3 and U4 which are connected back-to-back. In an example, the resistors R6, R7, R8 are each 100 k Ohm. A control terminal (e.g., the op amp 506) is coupled to the high impedance biasing component resistor R8. The control terminals of the series capacitive elements U3 and U4 are also coupled to two high impedance biasing components (e.g., resisters R8 and R7 respectively). In an example, the elements U3 and U4 are identical elements that constitute a differential-series transcap. The capacitive element U3 includes one terminal (i.e., the upper terminal in FIG. 6) connected to a RF+ area of the resonant network 500, and may be a gate-oxide and poly-silicon type terminal. The capacitive element U4 includes one terminal (e.g., the lower terminal in FIG. 6) connected to the RF- of the resonant network 500, which is also typically a gate-oxide and poly-silicon type terminal. The other terminals on the capacitive elements U3 and U4 that couple to R8 are generally configured as semiconductor junctions (e.g., either a p type or an n type).

A resonant circuit utilizing variable capacitor technology (e.g., MEMS capacitors, switch capacitors, BST variable capacitors, transcaps), such as the variable reactive element 504, may rely on cascading multiple cells (e.g., U3, U4) in order to withstand operational voltages and increase the linearity of the circuit. The high impedance biasing components (e.g., R6, R7, R8) effectively guarantee that the Q factor of the variable reactive element 504 is not reduced too much and enable the correct biasing of the variable reactive element 504. The Q factor relates to the losses a device has when it is placed in an operational circuit (e.g., the higher the Q value, the lower the losses). As a design trade off, however, the high impedance also limits the bandwidth of the variable capacitor. Additionally, the large resistance of the biasing components and the associated parasitic capacitance create an RC circuit with a large time constant (e.g., a long response time). The large time constant can impede the tuning speed of the variable reactive element 504. This increased tuning time due to the high impedance biasing components can create problems in time sensitive applications such as circuit protection and control systems when a resonant circuit should respond quickly. In a battery charging example, if an input changes quickly and results in more power than expected, if any variable capacitor is being used to control the power output (e.g., the battery charger) then there is a need to quickly control the reactance of the resonant network. In the absence of a quick control, the increase in input could damage the charger, the battery, or other elements in the resonant network (e.g., the variable capacitors in particular). The battery charging application is an example only, and not a limitation. A similar risk exists in other power transfer systems or system that employ resonant networks. That is, if a power input increases and the load is not changing, then voltages throughout the circuit may increase and may exceed the tolerances of one or more components in circuit.

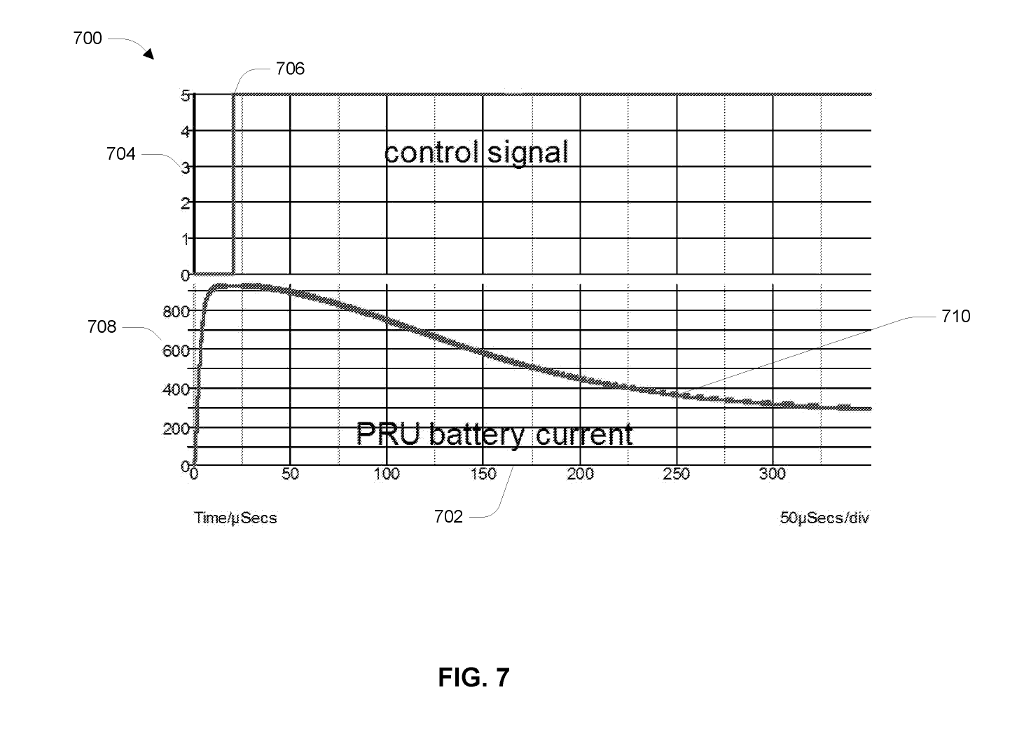

Referring to FIG. 7, a multivariable graph 700 of an example of signal response of a resonant network with the variable reactive element and high impedance components of FIG. 6 is shown. The multivariable graph 700 includes a time axis 702, a control voltage axis 704, a control signal value 706, a PRU battery current axis 708, and a PRU battery current value 710 (e.g., based on the battery voltage). The time axis 702 indicates time in microseconds (μsecs) with 50 μsecs per division. The control voltage axis 704 indicates values between 0 and 5 volts, and the PRU battery current axis 708 indicates values between 0 and 900 milliamps (mA). The multivariable graph 700 illustrates the impact of the high impedance biasing components to a change in a control signal at the variable reactive element 504. The control signal value 706 changes from 0 volts to 5 volts at approximately time equal to 24 μsecs. The PRU battery current value 710 begins to react at time 24 μsecs but does not realize the desired end point until approximately time 300 μsecs. This delay is due mainly to the large resistance associated with the input parasitic capacitances of the variable reactive element 504 (e.g., the control terminals with R6, R7). Delays in tuning speed as depicted in FIG. 7 could pose a serious limitation to the control of the output power, for instance when an abrupt load variation is experienced. If the variable reactive element 504 cannot react quickly enough, the lack of control of the output power for a small amount of time could have very serious consequences.

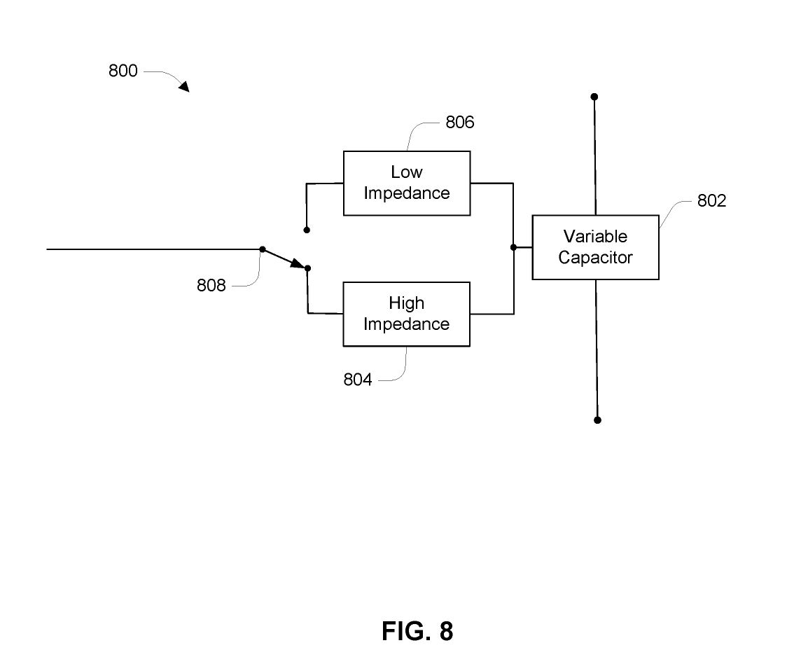

Referring to FIG. 8, a functional block diagram of an example of a circuit 800 with a variable capacitor and a selectable biasing component is shown. The circuit 800 includes a variable capacitor element 802, a high impedance biasing component 804, a low impedance biasing component 806, and a switch 808. In an example, the switch 808 and the biasing components 806, 808 may be a variable biasing means for impeding current flow proximate to the variable capacitor element 802. The variable capacitor element 802 may include transcaps, analog variable capacitor technologies, varactors, combinations of varactors, or BST dielectrics/devices. The high impedance biasing component 804 may include circuit elements with a relatively high (e.g., as compared to the low impedance biasing component 806) real impedance (e.g., resistors, back-to-back diodes, inductors, etc.). As an example, the high impedance biasing component 804 may have a real impedance value in the range of 50 k-200 k ohms, and the low impedance biasing component 806 may have a real impedance value in a range from a few milliohms to a few hundred ohms. In an example the low impedance biasing component 806 may create a bypass of the high impedance biasing component 804. The values of the impedance values may change based on the application, desired Q factor, desired tuning speed, and other design factors with the result that the time constant of the variable capacitor will reduce (e.g., speed up) when the switch 808 changes from the high impedance biasing component 804 to the low impedance biasing component 806. For example, a control signal (not shown) may cause the switch 808 to change based on a fast change across other resonant network system parameters, such as an output voltage/current or other control point (e.g., voltage across a receiving element). As an example, a fast change may occur within a duration of less than 1 millisecond, such as when a change in the relative positions of a transmitter and a receiver changes causes a near instantaneous change in the coupling value. The control signal can then cause the switch 808 to return to the high impedance position when the fast change in the parameter is no longer present (e.g., when the coupling value stop changing). The circuit 800 provides a solution based on the realization that for many applications tuning speed is critical during a fast parameter change across a resonant network, and generally less critical during normal operation. Therefore, the circuit 800 is configured to bypass entirely or partly the high impedance biasing component 804 for a short time in response to a large variation of a control signal (e.g., based on detecting a fast transient in the resonant network).

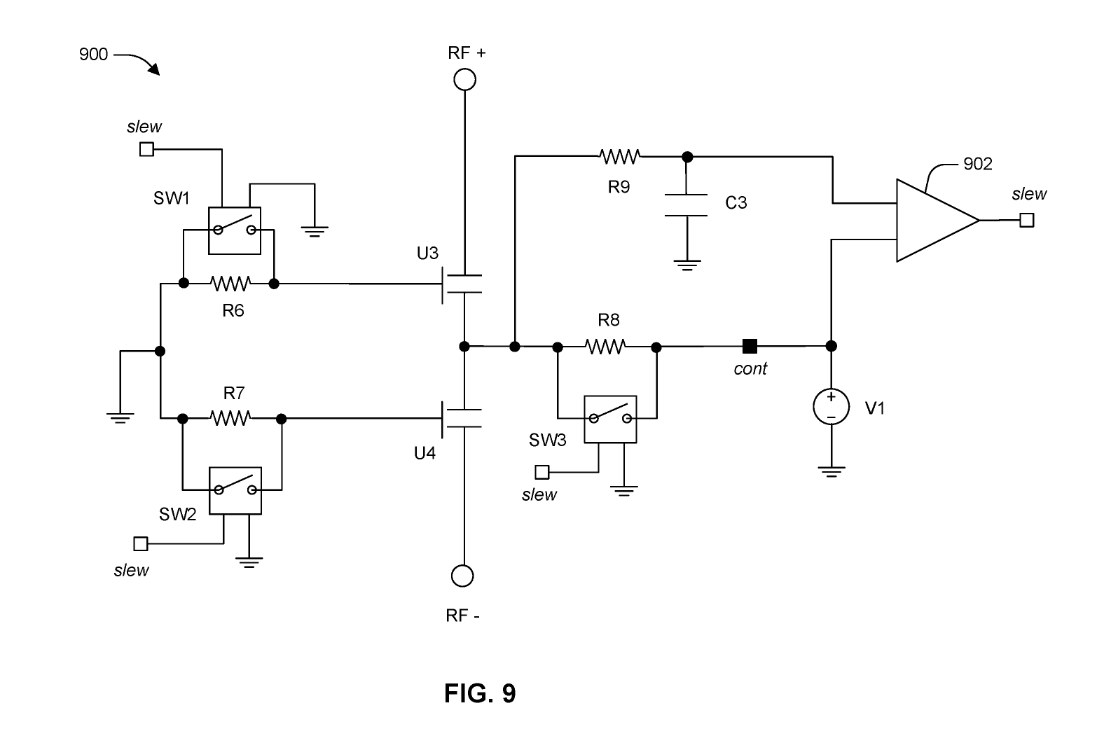

Referring to FIG. 9, with further reference to FIG. 5, a diagram of an example of a variable reactive element with a variable capacitor speed up circuit 900 is shown. The circuit 900 is an example of a variable capacitor circuit. The circuit 900 includes the capacitive elements U3, U4 and at least one biasing component such as the high impedance biasing components R6, R7, R8 as described in FIG. 5. The variable capacitor speed up circuit 900 also includes at least one switch such as a first ideal switch SW1 across R6, a second ideal SW2 across R7, and a third ideal switch SW3 across R8. A comparator 902 is operably coupled to a voltage generator V1 and a low pass filter including a high impedance resistor R9 and a capacitor C3. The ideal switches SW1, SW2, SW3 include a positive control element configured to receive a slew signal, and a negative element that is coupled to ground. The slew signal is generated by the comparator 902, and the output of the comparator 902 is configured to drive the control for the switches. The comparator 902 receives the control signal from V1 (e.g., the control signal value 706) and a common mode voltage measured on an internal control node of the differential series between the capacitive elements U3, U4. The comparator 902 is configured to compare one or more voltages. The comparator 902 is operably coupled to the internal control node via the low pass filter (e.g., 1 Mohm R9, and 1 pF capacitor C3). If there is a fast edge on the node generated by V1 (e.g., which describes a user/controller that wants to change the value of the variable capacitor quickly), then the inputs of the comparator 902 are different (e.g., there is a voltage across the input of the comparator 902). The midpoint of the differential series (e.g., between U3 and U4) and the low pass filter makes the output of the low pass filter relatively slow, and thus keeps the common mode. As a result, the V1 input to the comparator 902 changes relatively very fast and the other input to the comparator 902 changes very slow in comparison. As a result, the comparator 902 sees a differential voltage and increases the slew signal. This slew signal then drives the three ideal switches SW1, SW2, SW3 to close (e.g., and bypass the resistors R6, R7 and R8 respectively). This change in impedance reduces the time constant of the variable capacitor (e.g., the variable reactive element 504) significantly. Thus, the control signal value 706 (e.g., a first tuning value) reduces the impedance of the biasing components and varies the capacitance of the capacitive elements U3, U4. When desired capacitance value is realized, for example when the midpoint between the capacitive elements U3, U4 goes to a value corresponding to the control signal value (e.g., as determined on the comparator side of R8, labeled ‘cont’ in FIG. 9), and after the low pass filter reacts, the comparator will bring down the slew output and the ideal switches SW1, SW2, SW3 will return to their original open positions (e.g., not bypassing the high value resistors R6, R7, R8). The circuit of FIG. 9 is an example to facilitate the explanation of the variable capacitor speed up circuit. Other circuits may be used. For example, the comparator 902 may require a separate power source which may be a limiting factor for a smaller and more dynamic circuit.

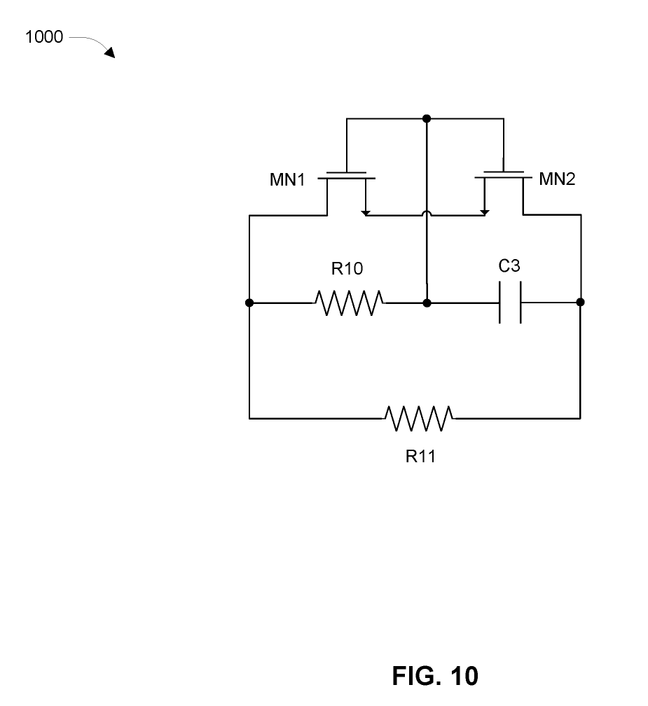

Referring to FIG. 10, an example of a switch 1000 to selectively reduce the impedance associated with a variable capacitor is shown. The switch 1000 includes a first n-channel MOSFET MN1, a second n-channel MOSFET MN2, a low pass RC filter including a resistor R10 and a capacitor C3, and a high impedance resistor R11. As used herein, a MOSFET is a metal-oxide-semiconductor field-effect transistor but the switch 1000 is not so limited as other transistors may be used. In an example, the RC resistor R10 is approximately 20 k ohms and C3 is in the range of 300 picofarads. The high impedance resistor R11 may be in the range from 100 k to 500 k ohms. The two MOS devices MN1, MN2 may be used to replace the ideal switches SW1, SW2, SW3 of FIG. 9. The MOS devices MN1, MN2, are coupled back to back (i.e., to prevent a signal from going through when signal flow is undesired) and are turned on when the voltage at the node between R10 and C3 is greater than the drain voltage for each MOS device. The circuit of FIG. 10 is a means to turn on and off the MOS devices MN1, MN2 (e.g., operating as switches) depending on the common mode voltage with respect to the voltage of the other two nodes.

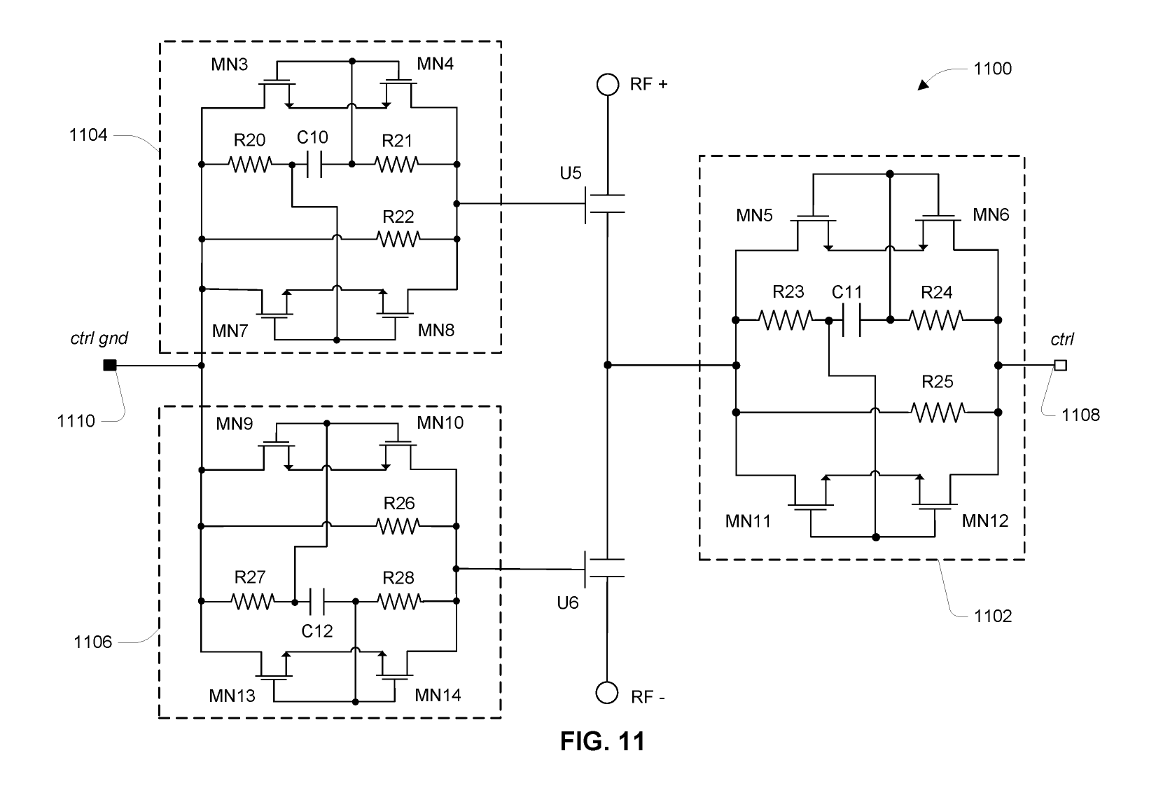

Referring to FIG. 11, with further reference to FIGS. 9 and 10, a more complete circuit 1100 for a differential series configuration variable capacitor is shown. The circuit 1100 is an example of a variable capacitor circuit. The circuit 1100 includes a first capacitive element U5, a second capacitive element U6, a first switchable high impedance biasing element 1102, a second switchable high impedance biasing element 1104, and a third switchable high impedance biasing element 1106. The first switchable high impedance biasing element 1102 includes a high impedance resistor R25, a RC low pass filter R23, C11, R24, and two sets of back-to-back n-channel MOSFET transistors with MN5, MN6 in a first set, and MN11, MN12 in the second set. The second and third switchable high impedance biasing elements 1104, 1106 include similar structures. For example, the second switchable high impedance biasing element 1104 includes a high impedance resistor R22, a RC low pass filter R20, C10, R21, and two sets of back-to-back n-channel MOSFET transistors with MN3, MN4 in a first set, and MN7, MN8 in the second set. The third switchable high impedance biasing element 1106 includes a high impedance resistor R26, a RC low pass filter R27, C12, R28, and two sets of back-to-back n-channel MOSFET transistors with MN9, MN10 in a first set, and MN13, MN14 in the second set. In an example, the high impedance resistors R22, R25, R26 have values between 100 k and 500 k ohms, the resistors in the RC low pass filters (e.g., R20, R21, R23, R24, R27, R28) have values between 10 k and 100 k ohms, and the capacitors in the RC low pass filters (e.g., C10, C11, C12) have values in a range between 1 picofarad and 300 picofarads. The values of the components may change based on application and/or performance requirements such as desired tune time, Q factor and required operating voltage. A control signal may be provided at a control node 1108, such that the control signal is measured with respect to a control ground 1110. The control node may be utilized to tune the first capacitive element U5 and second capacitive element U6 as described for the operational amplifier 506 in FIG. 5.

In operation, referring to the first switchable high impedance biasing element 1102, a control signal present at the control node 1108 may move fast from 0V to 5V (e.g., the control signal value 706). The fast control signal at the control node 1108 causes the drain of MN6 and the drain of MN12 to also move fast. When the voltage on the drains of MN6 and MN12 moves up fast, then the gates on MN6 and MN5 also go up fast because there is only R24 (e.g., 20 k ohm) between the gates and the control node 1108. The drain of MN5, however, is still at a relatively low value. If the control signal at the control node 1108 is a negative value, then MN11 and MN12 would turn on (i.e., rather than MN5 and MN6). The first switchable high impedance biasing element 1102 includes two sets of back-to-back n-channel MOSFET transistors to enable the devices to turn on when the edge of the control signal is either positive or negative (i.e., it is a bidirectional switch). The high impedance resistor R25 is the high value resistor in the circuit, the four MOSFET switches (MN5, MN6, MN11, MN12) turn on and off on based on whether the edge of the control signal at the control node 1108 is positive or negative. The RC time constant associated with the RC low pass filter (e.g., R23, C11, R24) is the time constant required to turn the first switchable high impedance biasing element 1102 back off after it is turned on. In this example, the voltage value of the control signal is a means for activating one or more switches.

That is, once the first switchable high impedance biasing element 1102 is turned on by the edge of the control signal, the RC low pass filter time constant brings the gate of the corresponding transistor back to low after the mid-node of the differential series (e.g., between U5, U6) goes to the desired voltage.

Resistors are shown in the examples, but other high impedance components may be used. For example, resistors with back-to-back diodes, RC networks, or inductors may be used as high impedance elements. In either case, a variable capacitor speed up circuit may bypass the impedance in a circuit that is used to bias the variable capacitor (e.g., based on Quality factor and tuning range, and linearity).

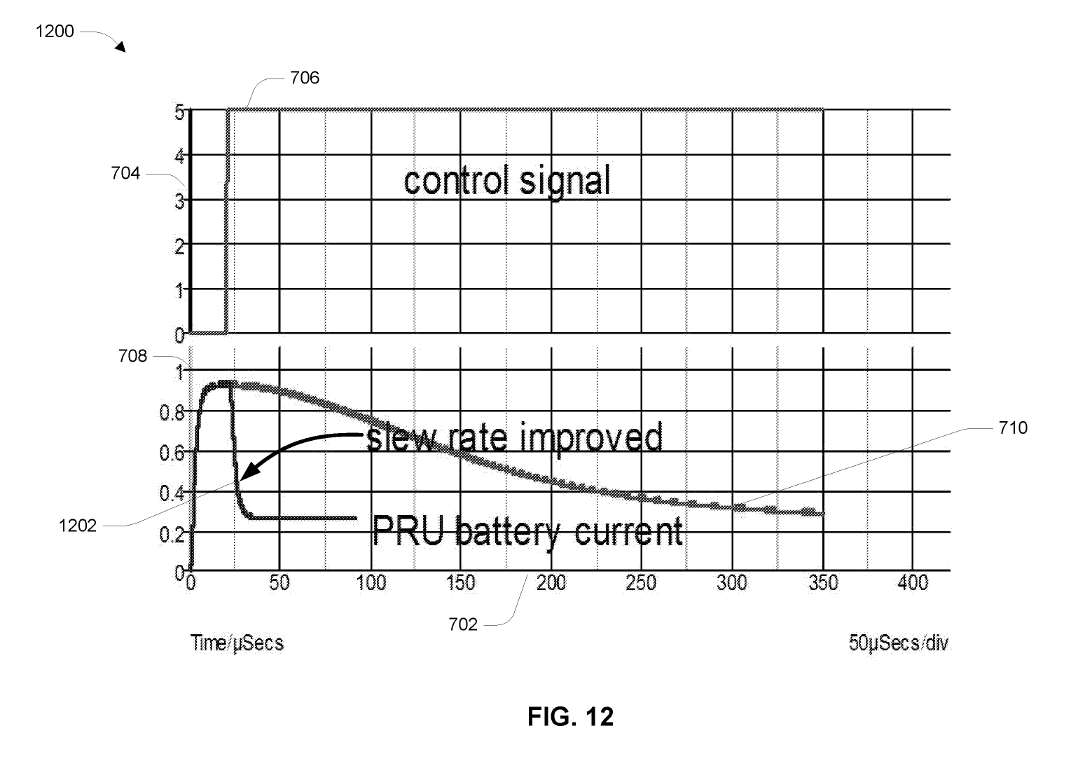

Referring to FIG. 12, with further reference to FIG. 7, a multivariable graph 1200 of an example of signal response of a resonant network with a variable capacitor speed up circuit is shown. The multivariable graph 1200 includes the time axis 702, the control voltage axis 704, the control signal value 706, the PRU battery current axis 708, the PRU battery current value 710, and the improved PRU battery current value 1202 (e.g., based on the battery voltage). The time axis 702 indicates time in microseconds (μsecs) with 50 μsecs per division. The control voltage axis 704 indicates values between 0 and 5 volts, and the PRU battery current axis 708 indicates values between 0 and 900 milliamps (mA). The multivariable graph 1200 illustrates the improvement in response time as compared to the multivariable graph 700 in FIG. 7. The control signal value 706 changes from 0 volts to 5 volts at approximately time equal to 24 μsecs. As previously discussed, the PRU battery current value 710 begins to react at time 24 μsecs and does not arrive at the desired end point for 300 μsecs. In contrast, the improved PRU battery current value 1202 illustrates the results when the high impedance bias elements are bypassed in response to the control signal value 706. The improved PRU battery current value 1202 realizes the desired value in approximately 20 μsecs (e.g., almost a 100× improvement in reaction time). Once the improved PRU battery current value 1202 achieves the desired value, then the high impedance bias elements may be restored (e.g., the bypass switches are opened such that the high impedance bias elements are back in the circuit) to maintain the expected Q factor and linearity.

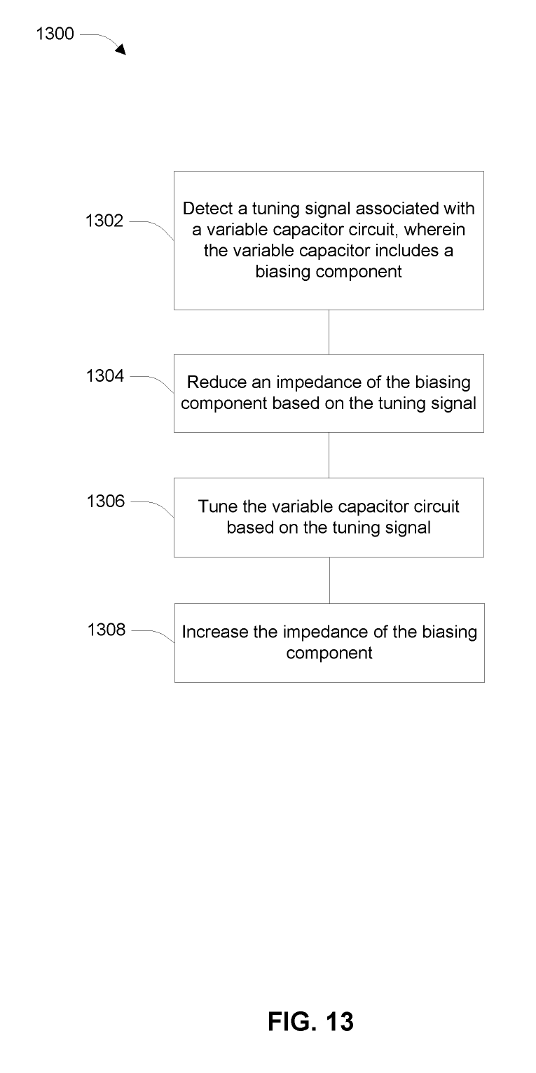

Referring to FIG. 13, an example of a process 1300 of controlling a resonant network with a variable capacitor speed up circuit is shown. The process 1300 is, however, an example only and not limiting. The process 1300 can be altered, e.g., by having stages added, removed, rearranged, combined, performed concurrently, and/or having single stages split into multiple stages. Other alterations to the process 1300 as shown and described are also possible.

At stage 1302, a control node (e.g., V1 in FIG. 9, 1108 in FIG. 11) detects a tuning signal associated with a variable capacitor circuit, wherein the variable capacitor circuit includes a biasing component. The variable capacitor circuit and biasing component may be the capacitive elements U3, U4 and the corresponding high impedance resistors R6, R7, R8 of FIG. 9. In an example, the capacitive elements U5, U6 and the corresponding high impedance resistors R22, R25, R26 of FIG. 11. In general, the tuning signal is created in response to a system change that may cause an overload or other unsafe condition in the resonant network 404, or accompanying circuitry. The tuning signal may be an analog voltage value (e.g., positive or negative) such as the control signal value 706. A control node is a means for detecting the tuning signal. The control circuit 408 may be configured to generate the tuning signal based on system parameters that are dependent on, or otherwise associated with, the resonant network 404 and/or the output 406. For example, the tuning signal may be associated with a current or voltage in the output 406 (e.g., PRU battery current). The tuning signal may be associated with a voltage or current in the resonant network (e.g., a voltage across a receiving antenna).

At stage 1304, the variable capacitor speed up circuit 900 reduces the impedance of the biasing component based on the tuning signal. In an example, one or more ideal switches SW1, SW2, SW3 may be activated to bypass a high impedance component based on the slew signal generated from the comparator 902 (e.g., by comparing one or more voltage values such as V1 and the midpoint between U3 and U4). In another example, the mode complete circuit 1100 with one or more transistors such as the n-channel MOSFETS MN5, MN6, MN11, MN12 in the first switchable high impedance biasing element 1102 may be a means for reducing the impedance of the biasing component based on the tuning signal. For example, the high impedance resistor R25 is the high value resistor in the mode complete circuit 1100, and the four MOSFET switches (MN5, MN6, MN11, MN12) turn on and off on based on whether the edge of the tuning signal at the control node 1108 is positive or negative. The variable capacitor speed up circuit 900 and mode complete circuit 1100 are examples only as other circuit configurations may be used. In general, referring to FIG. 8, the switch 808 represents the means to reduce the impedance of a biasing component based on a tuning signal. The switch 808 may be configured to remain in a high impedance position (i.e., connected to the high impedance biasing component 804) to increase the Q factor and linearity of the variable capacitor element 802. A tuning signal may cause the switch 808 to activated and bypass the high impedance biasing component 804 and switch to the low impedance biasing component 806 in response to a system parameter.

At stage 1306, the variable capacitor speed up circuit 900 tunes the variable capacitor circuit based on the tuning signal. The control circuit 408 may provide a voltage V1 to the comparator 902 to tune the differential series (e.g., capacitive elements U3, U4). In an example, the control circuit 408 may provide a signal to the control node 1108 in mode complete circuit 1100 to change the capacitive value of the differential series (e.g., capacitive elements U5, U6). The tuning signal provided to the control node 1108 may be a means for tuning and detuning a resonant network as well as activate the high impedance bypass switching (e.g., via the first switchable high impedance biasing element 1102, the second switchable high impedance biasing element 1104, and the third switchable high impedance biasing element 1106).

At stage 1308, the variable capacitor speed up circuit 900 increases the impedance biasing component. In an example, when the midpoint between the capacitive elements U3, U4 goes to a desired value (e.g., as detected on the comparator side of R8, labeled ‘cont’ in FIG. 9), and after the low pass filter reacts, the comparator 902 will bring down the slew output and the ideal switches SW1, SW2, SW3 will be activated to return to their original open positions (e.g., not bypassing the high value resistors R6, R7, R8). Similarly, in more complete circuit 1100, once the switchable high impedance biasing elements 1102, 1104, 1106 are turned on by the edge of the tuning signal, the RC low pass filter time constant brings the gate of the corresponding transistor back to low after the mid-node of the differential series (e.g., between U5, U6) goes to the desired voltage. In an example, the value of the control signal (i.e., when the desired capacitance value is realized) is a means for increasing the impedance of the biasing components.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. An apparatus for varying capacitance, comprising:
a variable capacitor circuit configured to vary a capacitance in response to a control signal;
at least one biasing component operably coupled to the variable capacitor circuit; and
a control circuit configured to:
generate the control signal, wherein the control signal includes a first tuning value corresponding to a first capacitance value; and
output the control signal at the first tuning value to reduce an impedance of the at least one biasing component and vary the capacitance of the variable capacitor circuit, wherein the impedance of the at least one biasing component subsequently increases when the first capacitance value is realized.

2. The apparatus of claim 1 wherein the at least one biasing component includes at least one switch configured to vary the impedance of the at least one biasing component based on the control signal.

3. The apparatus of claim 2 wherein the at least one switch includes an n-channel metal-oxide-semiconductor field-effect transistor (MOSFET).

4. The apparatus of claim 1 wherein the variable capacitor circuit is part of a resonant network including a power receiving element and the control circuit is configured to generate the control signal based at least in part on a voltage across the power receiving element.

5. The apparatus of claim 1 wherein the variable capacitor circuit is part of a resonant network including a battery charge controller and the control circuit is configured to generate the control signal based at least in part on a system parameter in the battery charge controller.

6. The apparatus of claim 1 wherein the variable capacitor circuit includes a transcap, an analog variable capacitor, a varactor, a Barium-Strontium Titanate (BST) dielectric, or combinations thereof.

7. The apparatus of claim 1 wherein the control signal is an analog voltage value.

8. The apparatus of claim 7 wherein the first tuning value is between 0.0 and 5.0 volts.

9. The apparatus of claim 1 wherein the at least one biasing component is a resistor.

10. The apparatus of claim 1 wherein the at least one biasing component is a back-to-back diodes, a Resistor Capacitor (RC) network, an inductor, or combinations thereof.

11. A method of controlling a resonant network with a variable capacitor circuit, comprising:
detecting a tuning signal associated with the variable capacitor circuit, wherein the variable capacitor circuit includes a biasing component;
reducing an impedance of the biasing component based on the tuning signal;
tuning the variable capacitor circuit based on the tuning signal; and
increasing the impedance of the biasing component.

12. The method of claim 11 wherein detecting the tuning signal includes comparing one or more voltage values.

13. The method of claim 11 wherein reducing the impedance of the biasing component includes activating a switch configured to bypass the biasing component.

14. The method of claim 13 wherein increasing the impedance of the biasing component includes activating the switch to not bypass the biasing component.

15. The method of claim 13 wherein activating the switch configured to bypass the biasing component includes providing a voltage to one or more transistors.

16. The method of claim 11 further comprising:
detecting a system parameter associated with the resonant network; and
generating the tuning signal based on the system parameter.

17. The method of claim 16 wherein the system parameter is an output current.

18. The method of claim 16 wherein the system parameter is a voltage across a power receiving element.

19. An apparatus for changing a time constant of a variable capacitor, comprising:
one or more variable capacitive elements;
at least one high impedance biasing component operably coupled to the one or more variable capacitive elements;
a switch operably coupled to the one or more variable capacitive elements and the at least one high impedance biasing component, wherein the switch is configured to bypass the at least one high impedance biasing component when activated.

20. The apparatus of claim 19 wherein the at least one high impedance biasing component is a resistor.

21. The apparatus of claim 19 wherein the at least one high impedance biasing component is a back-to-back diodes, a Resistor Capacitor (RC) network, an inductor, or combinations thereof.

22. The apparatus of claim 19 wherein the switch comprises one or more transistors.

23. The apparatus of claim 22 wherein the one or more transistors include back-to-back n-channel metal-oxide-semiconductor field-effect transistors (MOSFETs).

24. The apparatus of claim 19 wherein the one or more variable capacitive elements include Barium Strontium Titanate (BST) devices.

25. The apparatus of claim 19 wherein the one or more variable capacitive elements include a transcap variable capacitor.

26. The apparatus of claim 19 wherein the one or more variable capacitive elements are included in a resonant network comprising a power receiving element and a control circuit, wherein the control circuit is configured to provide a control signal to vary a capacitance value of the one or more variable capacitive elements based on a voltage in the power receiving element, and the switch is configured to activate based on the control signal.

27. An apparatus comprising:
one or more variable capacitive elements;
at least one variable biasing means for impeding current flow proximate to the one or more variable capacitive elements; and
a control means for varying a capacitance value of the one or more variable capacitive elements and an impedance value of the at least one variable biasing means.

28. The apparatus of claim 27 wherein the at least one variable biasing means includes a switch means operably coupled to the one or more variable capacitive elements and the control means, wherein the switch means is configured to bypass at least one high impedance biasing component when activated.

29. The apparatus of claim 28 wherein the switch means includes one or more transistors include back-to-back n-channel metal-oxide-semiconductor field-effect transistors (MOSFETs).

30. The apparatus of claim 27 wherein the at least one variable biasing means includes a resistor, a back-to-back diodes, a Resistor Capacitor (RC) network, an inductor, or combinations thereof.
